(19) United States
(12) Patent Application Publication
(10) Pub. No.: US 2013/0160557 A1
(43) Pub. Date: Jun. 27, 2013

(54) ACOUSTIC WAVE ACQUIRING APPARATUS

(71) Applicant: Canon Kabushiki Kaisha, Tokyo (JP)

(72) Inventors: Takao Nakajima, Kyoto-shi (JP); Yasufumi Asao, Kyoto-shi (JP)

(73) Assignee: CANON KABUSHIKI KAISHA, Tokyo (JP)

(21) Appl. No.: 13/718,595

(22) Filed: Dec. 18, 2012

(30) Foreign Application Priority Data
Dec. 26, 2011 (JP) 2011-283249
Apr. 20, 2012 (JP) 2012-096716

(51) Int. Cl. G01H 9/00; G01N 21/55

(52) U.S. Cl. CPC G01H 9/00; G01N 21/55
USPC 73/655

(57) ABSTRACT

Provided is a technique capable of changing resolution or an imaging area during imaging, in an acoustic wave acquiring apparatus using a Fabry-Perot probe. An acoustic wave acquiring apparatus includes a measurement light source emitting measurement light, a probe having a Fabry-Perot interferometer including a first mirror, upon the side of which the measurement light is incident, and a second mirror, upon the side of which an elastic wave from an object is incident, an optical system changing a beam diameter of the measurement light, a controller controlling change in the beam diameter performed by the optical system, a photosensor measuring a light intensity of the measurement light reflected on the Fabry-Perot interferometer, and a processor acquiring intensity of the elastic wave on the basis of change in the light intensity measured by the photosensor due to incidence of the elastic wave.

### BACKGROUND OF THE INVENTION

1. Field of the Invention

The present invention relates to an acoustic wave acquiring apparatus.

2. Description of the Related Art

In general, imaging apparatuses using an X-ray, an ultrasound wave, and an MRI (nuclear magnetic resonance method) are often used in the mechanical field. On the other hand, a study of an optical imaging apparatus that obtains information in a biological body by propagating, inside an object such as an biological body, light irradiated from a light source such as a laser, and detecting the propagated light and the like has been also actively advanced in the mechanical field. A photoacoustic tomography (PAT) is proposed as one of such optical imaging techniques.

The PAT is a technique of irradiating an object with pulsed light generated from a light source, detecting an acoustic wave generated from a biological tissue, which absorbs energy of light propagated and diffused in the object, on a plurality of portions, performing analytical processing to signals thereof, visualizing information related to optical properties of the inside of the object. The acoustic wave generated at this time is referred to also as a photoacoustic wave. Thus, optical properties distribution inside the object, particularly optical energy absorption density distribution can be obtained.

While examples of an acoustic wave detector include a transducer using a piezoelectric phenomenon or a transducer using change in a capacity, a detector using resonance of light has been developed recently.

When imaging apparatuses are put into practical use, it is important to perform imaging in a short period of time. In a case where an object is a biological body, particularly in a medical setting or the like, it is necessary to perform imaging in a short period of time, and reduce a burden of the object toward practical use.

In order to perform imaging in a short period of time, it is necessary to perform data acquisition in a short period of time. When raster scanning by a single probe is performed in order to acquire two-dimensional distribution data of a photoacoustic wave, significant time for data acquisition is required.

In Patent Literature 1 (Japanese Patent Application Laid-open No. 2005-218684), two-dimensional distribution of photoacoustic waves is acquired in a lump by using a two-dimensionally arrayed ultrasound probe. Thus, time required for data acquisition can be considerably reduced.

On the other hand, in the detector using resonance of light, there is a reported example of a method for detecting sound pressure of an ultrasound wave which is irradiated onto a Fabry-Perot interferometer by using a CCD camera as two-dimensional array sensor in order to obtain two-dimensional distribution of elastic waves all at once (Non Patent Literature 1: M. Lamont, P. Beard, “2D imaging of ultrasound fields using CCD array to map output of Fabry-Perot polymer film sensor”, Electronics Letters, 42, 3 (2006)).

If resolution or imaging range of the captured image can be changed during the imaging with a two-dimensional sensor, improvement of the accuracy in imaging and effective measurement will be expected.

In a medical setting, if resolution or the imaging range can be changed during imaging when a lesioned part of a biological body or the like, identification or extraction of the lesioned part can be effectively performed. For example, a portion suspected as a lesioned part is extracted by first acquiring a rough image having low resolution widely. Thereafter, resolution is increased, imaging of an extracted range is performed with a high definition, and the portion suspected as the lesioned part is fully examined. Thus, the lesioned part can be effectively examined.
Patent Literature 1: Japanese Patent Application Laid-open No. 2005-218684
Non Patent Literature 1: M. Lamont, P. Beard, “2D imaging of ultrasound fields using CCD array to map output of Fabry-Perot polymer film sensor”, Electronics Letters, 42, 3 (2006)

### SUMMARY OF THE INVENTION

However, when imaging is performed by using a two-dimensional array ultrasound probe as in Japanese Patent Application Laid-open No. 2005-218684, resolution is determined by a receiving area of a single receiving element. Further, an imaging area is determined by size (aperture) of the two-dimensional array ultrasound probe.

Therefore, in a method of imaging by using a conventional two-dimensional array ultrasound probe, in order to change the resolution or the imaging area, it is necessary to replace the two-dimensional array ultrasound probe with another two-dimensional array ultrasound probe with a different receiving area of a receiving element or a different aperture of an ultrasound probe.

That is, the resolution and the imaging range cannot be changed during imaging. The imaging is stopped, and then the probe has to be replaced. However, replacement of the probe causes increase in total imaging time. Moreover, a position and shape of the object is changed during replacement, imaging in the same condition cannot be attained, and comparison between an image before replacement and an image after replacement is difficult. Accordingly, accuracy of identification or extraction of a lesioned part is lowered.

Although imaging is performed by using a two-dimensional array photosensor in the Non Patent Literature 1, resolution or the imaging range cannot be changed in the aforementioned document because a lens or the like is not placed in the optical path of a measurement light irradiated from laser diode.

Moreover, when imaging is performed by using a two-dimensional array photosensor, incident angle of a light beam into a Fabry-Perot sensor or the two-dimensional array photosensor and image formation relationship exert influence on quality of the sensor, such as sensitivity characteristics. However, Non Patent Literature 1 does not disclose this light beam in detail.

The present invention has been conceived in order to solve the aforementioned problems, and the object thereof is to provide a technique capable of changing resolution or an imaging area during imaging in an acoustic wave acquiring apparatus using a Fabry-Perot probe.

The present invention provides an acoustic wave acquiring apparatus comprising:

a measurement light source configured to irradiate measurement light;

a probe having a Fabry-Perot interferometer including a first mirror, upon the side of which the measurement light is incident, and a second mirror, upon the side of which an elastic wave from an object is incident;

an optical system configured to change a beam diameter of the measurement light;

a controller configured to control the change in the beam diameter performed by the optical system;

a photosensor configured to measure a light intensity of the measurement light reflected on the Fabry-Perot interferometer; and

a processor configured to acquire intensity of the elastic wave on the basis of the change in the light intensity measured by the photosensor due to incidence of the elastic wave.

According to the present invention, it is possible to provide a technique capable of changing resolution or an imaging area during imaging in an acoustic wave acquiring apparatus using a Fabry-Perot probe.

Further features of the present invention will become apparent from the following description of exemplary embodiments with reference to the attached drawings.

### BRIEF DESCRIPTION OF THE DRAWINGS

FIG. 1 is a figure showing an example of a configuration of an imaging apparatus;

FIG. 2 is a figure showing an example of a configuration of a Fabry-Perot interferometer of the present invention;

FIG. 3 is a figure showing an example of a configuration of a Fabry-Perot probe of the present invention;

FIG. 4 is a figure showing an example of a configuration of an imaging apparatus of the present invention;

FIG. 5 is a figure showing an example of a configuration of an imaging apparatus of the present invention;

FIG. 6 is a figure showing an example of a configuration of an imaging apparatus of the present invention; and

FIG. 7A to FIG. 7C are graphs showing an example of relationship among a beam diameter, resolution, and an imaging range of the present invention.

FIG. 8 is a figure showing an example of a configuration of a zoom optical system of the present invention.

### DESCRIPTION OF THE EMBODIMENTS

Hereinafter, preferred embodiments of the present invention will be described with reference to figures. However, size, quality of materials, shape, relative arrangement thereof, and the like should be appropriately changed according to a configuration of an apparatus to which the invention is applied, or various conditions, and the scope of this invention is not limited to the description as below.

An acoustic wave acquiring apparatus of the present invention includes an imaging apparatus utilizing an ultrasound wave echo technique of transmitting an acoustic wave such as an ultrasound wave to an object, receiving a reflected wave (echo wave) reflected and propagated inside the object, and acquiring object information as image data. Additionally, the acoustic wave acquiring apparatus includes an imaging apparatus utilizing a photoacoustic effect (photoacoustic effect) of receiving an acoustic wave generated and propagated inside the object by irradiation of light (electromagnetic wave) to an object, and acquiring object information as image data.

In a case of the former apparatus utilizing the ultrasound wave echo technique, the acquired object information is information reflecting difference in acoustic impedance of tissues inside the object. In a case of the latter apparatus utilizing the photoacoustic effect, the acquired object information indicates generation source distribution of acoustic waves generated by light irradiation, or initial sound pressure distribution inside the object, optical energy absorption density distribution or absorption coefficient distribution derived from the initial sound pressure distribution, or concentration distribution of substances configuring a tissue. The concentration distribution of substances includes oxygen saturation distribution, oxygenated/reduced hemoglobin concentration distribution, or the like, for example.

An Acoustic wave in the present invention is typically an ultrasound wave, and includes an elastic wave referred to as a sound wave or an acoustic wave. An acoustic wave generated by a photoacoustic effect is referred to as a photoacoustic wave, or a light-induced ultrasound wave. The apparatus of the present invention receives an acoustic wave generated or reflected and propagated inside the object by an acoustic wavedetector such as a probe.

### First Embodiment

The preferred embodiment of the present invention will be described with reference to figures.

A concept of measurement light in the present invention includes incident light incident upon a Fabry-Perot interferometer, and reflected light reflected by the Fabry-Perot interferometer to be led to an array photosensor. The measurement light is distinguished from excitation light irradiated to an object in order to generate an acoustic wave by utilizing a photoacoustic effect.

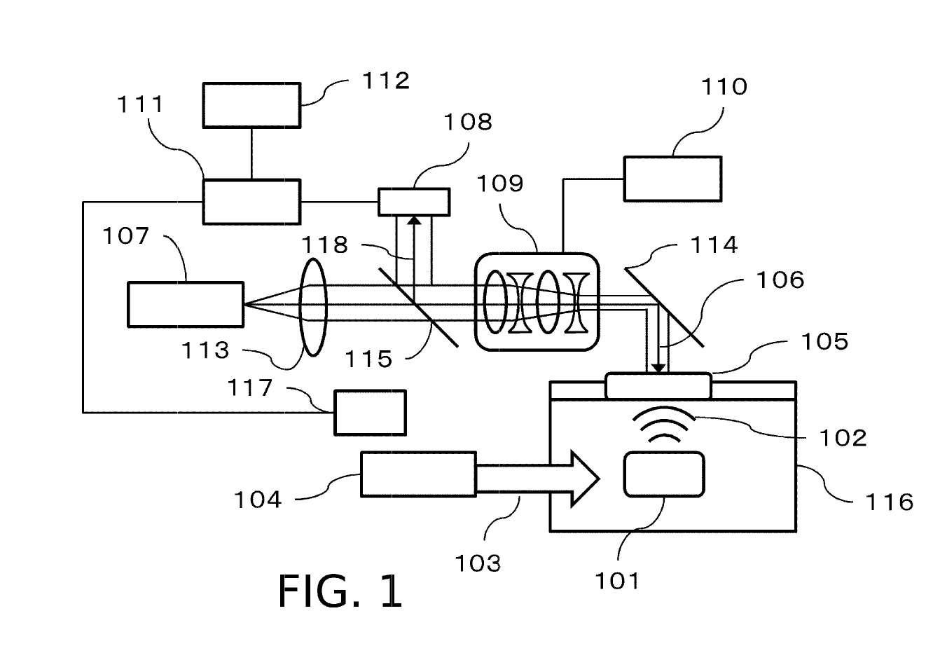

FIG. 1 is a figure illustrating a configuration example of an imaging apparatus according to the present embodiment.

The imaging apparatus according to the present embodiment includes an excitation light source 104. The excitation light source 104 irradiates an object 101 with excitation light 103. As a result, a light absorber inside or on a surface of the object 101 absorbs a part of light energy, so that a photoacoustic wave 102 generates. Examples of the light absorber inside the object include a tumor, a blood vessel and the like.

The imaging apparatus includes a Fabry-Perot probe 105 for detecting the photoacoustic wave 102. The Fabry-Perot probe 105 can detect sound pressure of the photoacoustic wave 102 by irradiating measurement light 106 from a measurement light source 107. The imaging apparatus also includes an array photosensor 108 for measuring a light intensity of reflected light of the measurement light 106 incident upon the Fabry-Perot probe 105 and converting the same into an electric signal. Furthermore, the imaging apparatus includes an optical system 109 for changing a beam diameter of the measurement light, and a controller 110 for controlling change in the aforementioned beam diameter. The aforementioned components are basic elements constituting the acoustic wave acquiring apparatus.

The imaging apparatus is configured by further including a processor 111 and a display unit 112 in the aforementioned acoustic wave acquiring apparatus. The processor 111 performs signal processing such as analysis to the electric signal obtained by the array photosensor 108, and the display unit 112 displays object information such as optical properties distribution obtained by the processor.

As the measurement light source 107 emitting the measurement light 106, a wavelength tunable laser can be used. Reflectance of the measurement light 106 is preferably 90% or more with respect to each of the two mirrors constituting the Fabry-Perot probe 105. Additionally, as a wavelength of the measurement light 106, an optimum wavelength in which sensitivity of the Fabry-Perot probe is maximized is preferably used.

The measurement light 106 is expanded by the lens 113, passes through the optical system 109 for changing a beam diameter of measurement light, and becomes incident light to the Fabry-Perot probe 105. The incident light is reflected by the Fabry-Perot probe, and thereafter passes through the optical system 109 for changing a beam diameter of measurement light again. At this time, a beam diameter of reflected light 118 returns to a beam diameter before the incident light passes through the optical system 109. Thereafter, the reflected light 118 is incident upon the array photosensor 108, so that reflection intensity distribution on the Fabry-Perot probe 105 can be obtained.

As an optical system for leading measurement light, a mirror 114 and a half mirror 115 are used. As long as these mirrors each have a configuration in which a light intensity of reflected light in the Fabry-Perot probe 105 can be measured, a configuration in which a polarizing mirror and a wave plate are used in place of the half mirror 115 can be employed.

As the optical system 109 for changing a beam diameter of measurement light between the mirror 114 and the half mirror 115, a zoom lens optical system can be used. The zoom lens optical system is configured, for example, from combination of a convex lens and a concave lens, and the controller 110 controls a distance between the lenses, so that the beam diameter can be freely changed.

Moreover, the optical system 109 is preferably composed of an object-space telecentric optical system so as not to cause variability in sensitivity due to the detection position of the Fabry-Perot probe. The reason for this will be described later.

Furthermore, the optical system 109 is preferably composed of a double telecentric optical system so as not to cause decrease in light reception efficiency at the time of oblique incidence of light flux into the array photosensor 108. In addition, the optical system 109 is also preferably composed of a double telecentric optical system so as to homologize the positions on the Fabry-Perot probe 105 with the pixels on the array photosensor 108.

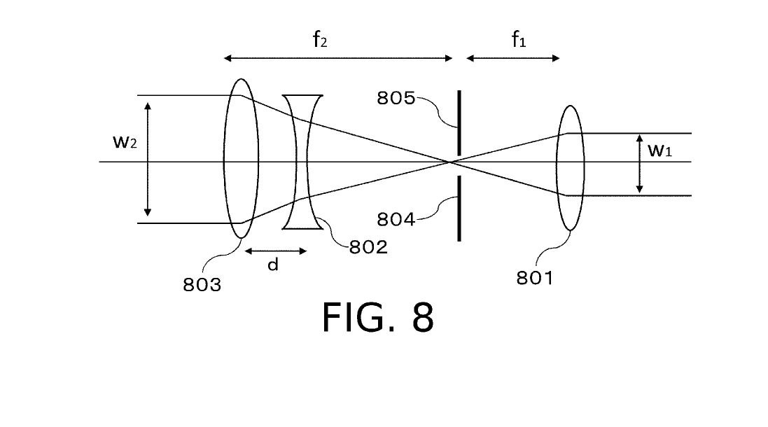

FIG. 8 shows an example of a zoom lens optical system.

The optical system is configured from a stationary convex lens 801 and movable concave lens 802 and convex lens 803. Here, focal distance of the convex lens 801 is f₁, synthesized focal distance of the concave lens 802 and convex lens 803 is f₂. In this case, f₂ becomes movable by changing the distance d between the concave lens 802 and convex lens 803.

The movable concave lens 802 and the convex lens 803 are moved so that the synthesized focal point of the concave lens 802 and the convex lens 803 is placed at the focal point 804 of the stationary convex lens 801. In this case, magnifying power w₁/w₂ is set as f₁/f₂.

As described above, needed magnifying power can be obtained by adjusting the distance d between the concave lens 802 and convex lens 803, and, the distance from the focal point 804 of the convex lens 801 to the concave lens 802 and convex lens 803.

The Fabry-Perot probe is arranged at the rear side of the convex lens 801 (opposite side of the focal point 804), thus the optical system becomes an object-space telecentric zoom lens optical system.

In the above-described FIG. 1, the mirror 114 can be preferably moved in a parallel fashion, or a direction thereof can be preferably changed. Thus, a position, at which a picture is created, on the Fabry-Perot probe 105 can be changed. A position on the Fabry-Perot probe 105 can be correlated to a pixel on the array photosensor 108 by combining these optical components with the zoom lens optical system.

When a beam diameter of the incident light 106 is reduced by using the optical system 109, an irradiation area of the incident light 106 incident upon the Fabry-Perot probe 105 is reduced as compared with a case where the optical system 109 is not used. On the other hand, a beam diameter when the reflected light 118 is incident upon the array photosensor 108 returns to size when a laser is first emitted, by passing through the optical system 109, and hence does not change. Therefore, a corresponding spot area on the Fabry-Perot probe 105 per pixel on the array photosensor 108 is reduced. Thus, resolution of the obtained image is increased. Additionally, the beam diameter of the incident light 106 incident upon the Fabry-Perot probe 205 is small, and hence an imaging area is narrowed.

On the contrary, when the beam diameter of the incident light 106 is increased by the optical system 109, resolution is reduced, but the imaging area of an image is widened.

Thus, the resolution and the imaging area can be changed by changing the beam diameter of the measurement light 106 by using the optical system 109. A measurer controls the optical system by using the controller 110 according to desired resolution or imaging range (performs zoom control in a case of the zoom lens optical system).

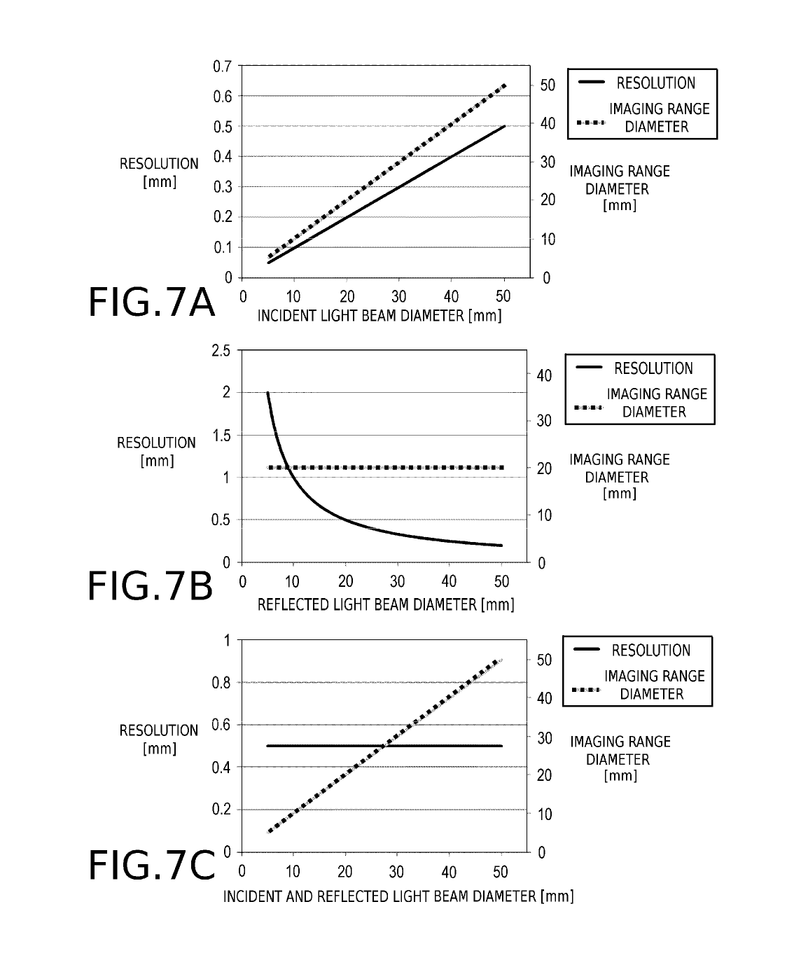

FIG. 7A shows an example of relationship among a beam diameter of incident light (horizontal axis), resolution (left vertical axis), and a diameter of an imaging area (right vertical axis) when the beam diameter of the measurement light 106 is changed by the optical system 109. It is found that the smaller the beam diameter of the incident light is, the narrower the diameter of the imaging range is while attaining higher-definition of the resolution.

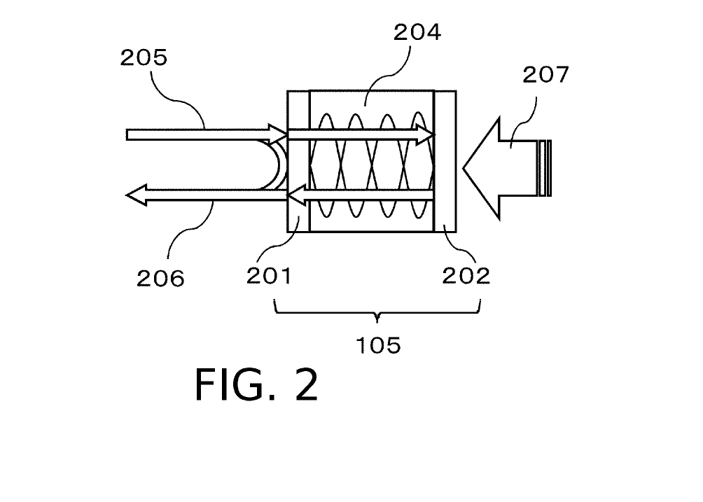

FIG. 2 is a schematic figure of an acoustic wavedetector using resonance of light. A configuration in which light is resonated between two parallel reflective plates, shown in this figure, is called a Fabry-Perot interferometer. Hereinafter, the acoustic wavedetector utilizing the Fabry-Perot interferometer is referred to as a Fabry-Perot probe.

The Fabry-Perot probe has a configuration in which a polymer film 204 having a thickness d is held between a first mirror 201 and a second mirror 202. The first mirror 201 is a mirror on a side where measurement light is incident, and the second mirror 202 is a mirror on a side where an acoustic wave is incident, opposite thereto. A measurement light source applies an incident light 205 to the interferometer from the side of the first mirror 201.

At this time, a light intensity Ir of reflected light 206 is shown in the following formula (1).

$$\begin{matrix}[ Math . 1 ] & \\ {I}_{r} = \frac{4 R {sin}^{2} \frac{ϕ}{2}}{{( 1 - R )}^{2} + 4 R {sin}^{2} \frac{ϕ}{2}} {I}_{i} & ( 1 ) \\ ϕ = \frac{4 π}{{λ}_{0}} nd & ( 2 )\end{matrix}$$

Here, Ii denotes a light intensity of incident light 205, R denotes reflectance of the first mirror 201 and the second mirror 202, λ₀ denotes a wavelength of the incident light 205 and the reflected light 206, d denotes an intermirror distance, and n denotes a reflective index of the polymer film 204. φ corresponds to phase difference in reciprocating between the two mirrors, and is represented by a formula (2).

When an acoustic wave 207 is incident upon the Fabry-Perot probe, the intermirror distance d changes. As a result of change of φ with change of d, reflectance Ir/Ii changes. Accordingly, the incident acoustic wave 207 can be detected by measuring change in a light intensity Ir of reflected light with a photodiode or the like. The larger the change in the light intensity of reflected light is, the larger an intensity of the incident acoustic wave 207 is.

In the Fabry-Perot probe, the change in the light intensity of reflected light only at a position illuminated with the incident light 205 is measured, and hence a spot area of the incident light 205 is an area with receiving sensitivity.

On the other hand, the receiving area can be reduced by narrowing down the incident light 205 with a lens or the like. Thus, size of the spot with receiving sensitivity is reduced, and hence resolution of an image when reconfigured is improved. Additionally, the Fabry-Perot probe has a wide reception frequency band of an acoustic wave in comparison with probes using PZT. From these reasons, a high-definition image with high resolution can be obtained by using the Fabry-Perot probe.

In FIG. 2, the incident light 205 enters a mirror surface of the first mirror 201 vertically. However, if the incident light 205 is tilted at an angle of θ degrees from the mirror surface, the optical path length changes during repeated reflection between the mirrors, thus φ is calculated according, not to formula (2), but to formula (3).

$$\begin{matrix}[ Math . 2 ] & \\ ϕ = \frac{4 π}{{λ}_{0}} nd \cdot cos θ & ( 3 )\end{matrix}$$

This means that change of the light intensity Ir of reflected light when the acoustic wave 207 enters the Fabry-Perot probe varies depending on the incident angle of light. This also means that a distance between the mirrors when a light having some wavelength resonates varies depending on the position.

Therefore, if the incident angle of the incident light 205 to mirror surface of the first mirror 201 varies depending on the incident position, the sensitivity disperses depending on the position of the Fabry-Perot probe. Moreover, the sound pressure cannot be measured if the tilt angle is large. Consequently, accurate two-dimensional distribution data of the acoustic wave cannot be obtained.

For that reason, preferably, the incident light 205 enters all positions on the Fabry-Perot probe vertically. That is, preferably, the optical system which introduces the incident light 205 to the Fabry-Perot probe is a object-space telecentric optical system when the Fabry-Perot probe is defined as an object side.

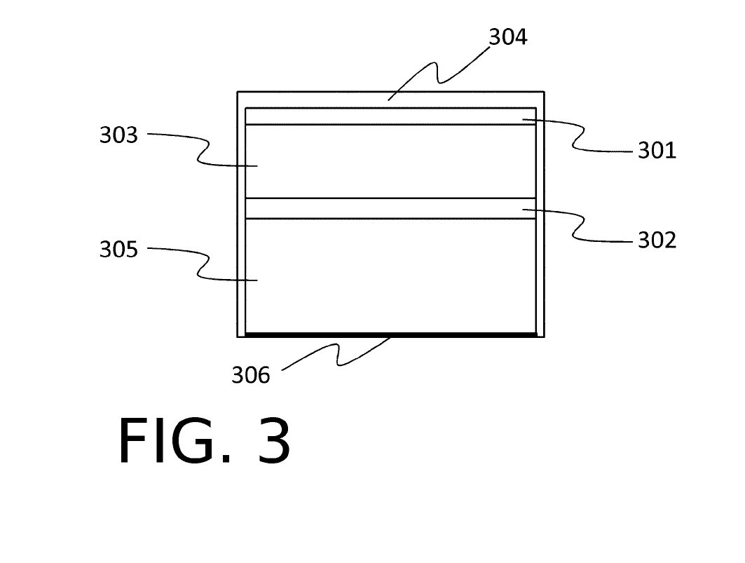

FIG. 3 is a figure illustrating a cross-section structure of a Fabry-Perot probe according to the present embodiment. A dielectric multilayer film or a metal film can be used as materials of a first mirror 301 and a second mirror 302. A spacer film 303 is present between the mirrors. As the spacer film 303, strain when an elastic wave is incident upon the Fabry-Perot probe is preferably large, for example, an organic polymer film is used. As the organic polymer film, parylene, SU8, polyethylene or the like can be used. However, as long as the film is a film which is deformed when receiving a sound wave, an inorganic film may be used.

The Fabry-Perot probe as a whole is protected by a protective film 304. As the protective film 304, a film obtained by thin-film formation of an organic polymer film such as parylene or of an inorganic film such as SiO2 is used. Glass or acrylic can be used for a substrate 305 on which the second mirror 302 is formed. At this time, in order to reduce an influence by light interference in the substrate 305, the substrate 305 is preferably formed in a wedge shape. Furthermore, in order to avoid light reflection on a surface of the substrate 305, the substrate 305 is preferably subjected to AR coating treatment 306.

As the array photosensor 108, a two-dimensional array photosensor or a one-dimensional array photosensor can be used. For example, a CCD sensor or a CMOS sensor can be used. However, as long as the array photosensor 108 is a sensor capable of measuring the light intensity of reflected light of the measurement light 106 when the photoacoustic wave 102 is incident upon the Fabry-Perot probe 105 and converting the same into an electric signal, an array photosensor other than the above can be also used.

For the excitation light 103 irradiated to the object 101, light with such a wavelength that the light is absorbed in a specific constituent in constituents configuring the object 101 can be used. For the excitation light 103, pulsed light can be used. The pulsed light is pulsed light of several picoseconds order to several hundred nanoseconds order. In a case where the object is a biological body, pulsed light of several nanoseconds to several ten nanoseconds is preferably employed. As the excitation light source 104 generating the excitation light 103, a laser is preferable. However, a light-emitting diode, a flashlamp or the like can be used in place of the laser.

As the laser, various lasers such as a solid-state laser, a gas laser, a dye laser and a semiconductor laser can be used. If an optical parametric oscillator (OPO) or dye capable of changing an oscillating wavelength is used, difference in a wavelength of the optical properties distribution can be measured.

As for a wavelength of the used light source, a range of 700 nm to 1100 nm of less absorption in the biological body is preferable. However, a wavelength range wider than the aforementioned wavelength range, for example, a wavelength range of 400 nm to 1600 nm, a terahertz wave range, a microwave range, or a radio wage range can be also used.

In FIG. 1, the excitation light 103 is irradiated to the object from a direction not to shadow the Fabry-Perot probe 105. However, the excitation light 103 can be also irradiated from a side of the Fabry-Perot probe 105 by employing a wavelength of light transmitted through a mirror of the Fabry-Perot probe 105 as the excitation light 103.

In order to effectively detect the photoacoustic wave 102 generated from the object 101 with the Fabry-Perot probe 105, it is desirable to use an acoustic coupling medium between the object 101 and the Fabry-Perot probe 105. In FIG. 1, water is used as the acoustic coupling medium, and acoustic matching is between the object 101 arranged in a water tank 116 and the probe. However, the acoustic coupling medium is not limited to water. For example, a configuration in which an acoustic impedance matching gel is applied between the object 101 and the Fabry-Perot probe 105 may be employed.

When the apparatus is used for medical application such as measurement of a part of a human body as the object, the water tank 116 is not used. In this case, the acoustic impedance matching gel is applied to the object, namely an affected part, the Fabry-Perot probe 105 is arranged on the affected part so as to be in contact with the same, and imaging is performed. At this time, the acoustic coupling medium is not limited to the matching gel. As long as acoustic matching is taken between the affected part and the Fabry-Perot probe 105, other medium can be used as the acoustic coupling medium.

Acquisition of the photoacoustic wave (ultrasound wave) 102 is started by a trigger of detection of the excitation light 103 by a photodiode (PD) 117. That is, when the excitation light 103 is irradiated to the object 101, the photoacoustic wave 102 is generated and propagated. On the other hand, the Fabry-Perot probe 105 detects the photoacoustic wave 102 as light intensity change of the reflected light 118, and the array photosensor 108 converts this light intensity change into an electric signal. Thus, object information generated in the object can be generated from the electric signals based on the photoacoustic waves 102 for a predetermined time period from the timing of detection of the trigger by the PD 117.

Distribution of the electric signals in the array photosensor 108 represents intensity distribution (pressure distribution) of the photoacoustic waves 102 reaching on an area, to which the measurement light 106 is irradiated, in the Fabry-Perot probe 105.

As reconstruction algorithm of the processor 111, for obtaining the object information such as the optical properties distribution from the distribution of the obtained electric signals, universal back projection or phase rectifying addition can be employed. As long as the processor 111 is a processor capable of storing distribution of time change of electric signals representing intensity of the photoacoustic wave 102 and converting the same into data of the optical properties distribution by computing means, any processor can be used as the processor 111.

After previously considering that an area, in which a film thickness significantly indicates an abnormality such as presence of a foreign material in an element, cannot be utilized as data, a data defective part is corrected at the time of image reconstruction processing and a picture of the part can be created.

Furthermore, suitable data processing is made possible by changing an reconstruction area and a voxel pitch according to the beam diameter of the measurement light 106 when performing the image reconstruction, thereby allowing image quality to be improved. That is, in a case where the beam diameter is wide, the imaging area is wide and the resolution is low. Accordingly, the reconstruction area is in a range corresponding to a spot area of a beam, and the voxel pitch can be increased according to the low resolution.

In a case where light of a plurality of wavelengths is used as the excitation light 103, an optical coefficient in the biological body is calculated for each of the wavelengths, and the values and wavelength dependence inherent in substances (glucose, collagen, oxygenated/reduced hemoglobin, and the like) constituting a biological tissue are compared with each other. To due this, it is also possible to create the picture of the concentration distribution of the substances constituting the biological body.

Furthermore, the apparatus desirably includes the display unit 112 displaying the image information obtained by the signal processing.

By using the imaging apparatus described above, it is possible to obtain an image while changing the resolution or the imaging area during imaging by using the Fabry-Perot probe 105.

### Second Embodiment

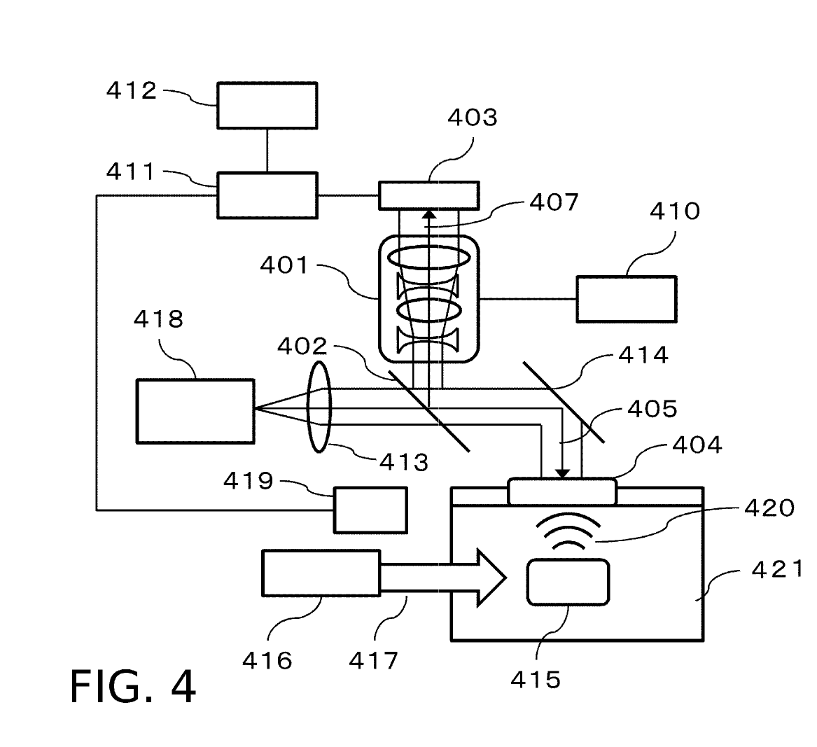

FIG. 4 is a figure illustrating a configuration example of an imaging apparatus according to the present embodiment.

In the imaging apparatus according to the present embodiment, a configuration of the apparatus and the like are similar to those of the first embodiment except a position where a zoom lens optical system 401 is arranged. That is, since a processor 411, a display unit 412, a controller 410, a mirror 414, a measurement light source 418, a lens 413, a PD 419, an excitation light source 416, and a water tank 421 have the same functions as those of the first embodiment, the detailed description thereof will not be repeated. Additionally, a point that excitation light 417 is irradiated to an object 415, and a photoacoustic wave 420 is generated and propagated is also similar to the first embodiment.

According to the present embodiment, the optical system 401 configured from the zoom lens optical system is located between a half mirror 402 and an array photosensor 403.

As a result, a beam diameter of reflected light 407 reflected from a Fabry-Perot probe 404 can be changed by the optical system 401. On the other hand, a beam diameter of incident light 405 does not change. Thus, only resolution can be changed without changing an imaging area.

For example, when the beam diameter of the reflected light 407 is increased by the optical system 401, a corresponding spot area on the Fabry-Perot probe 404 per pixel on the array photosensor 403 is reduced. Thus, resolution of an obtained image is increased.

On the contrary, when the beam diameter of the reflected light 407 is reduced by the optical system 401, resolution is reduced.

Thus, the beam diameter of the reflected light 407 is changed by the optical system 401, so that the resolution can be changed while keeping the imaging area constant. A measurer controls the optical system 401 by using the controller, that is, performs zoom control of the zoom lens optical system according to desired resolution.

FIG. 7B shows an example of relationship among a beam diameter of reflected light (horizontal axis), resolution (left vertical axis), and a diameter of an imaging area (right vertical axis) when the beam diameter of the reflected light 407 is changed by the optical system 401. As shown in the figure, when the beam diameter of the reflected light is reduced, an area on the array photosensor 403 corresponding to an area to which the incident light is irradiated (diameter of the imaging area) is reduced, and hence the resolution is reduced.

In this embodiment, the zoom lens optical system 401 is preferably a telecentric optical system so as not to cause decrease in light reception efficiency at the time of oblique incidence of light flux into the array photosensor 404.

By using such an imaging apparatus shown in the second embodiment, it is possible to obtain an image while changing the resolution during imaging by using the Fabry-Perot probe 404.

### Third Embodiment

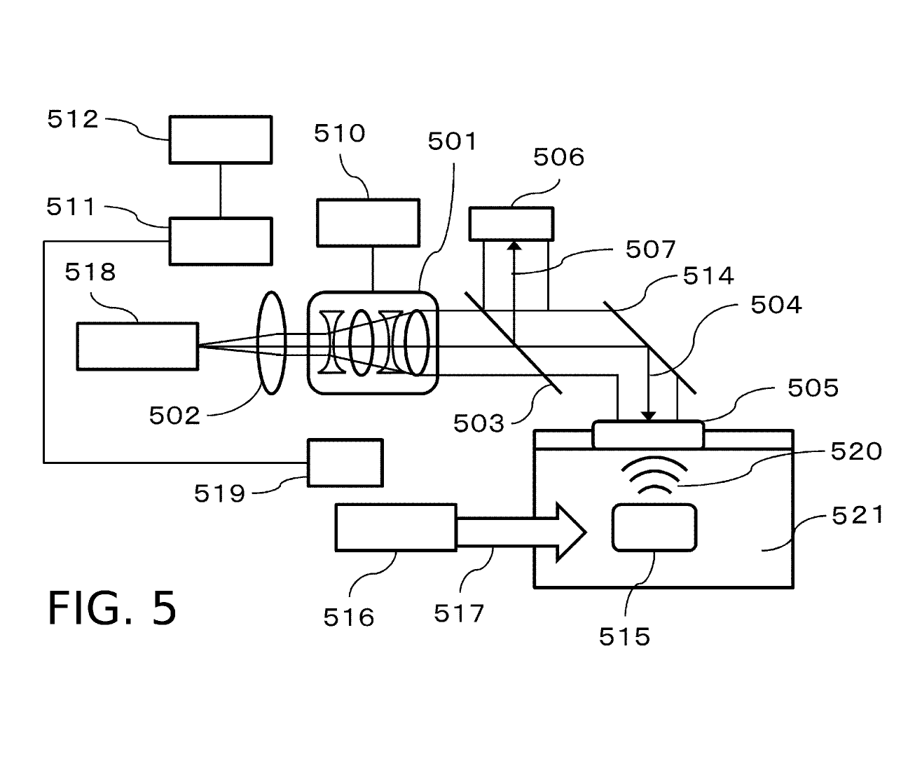

FIG. 5 is a figure illustrating a configuration example of an imaging apparatus according to the present embodiment.

In the imaging apparatus according to the present embodiment, a configuration of the apparatus and the like are similar to those of the first embodiment except a position where a zoom lens optical system 501 is arranged. That is, a processor 511, a display unit 512, a controller 510, a mirror 514, a measurement light source 518, a PD 519, an excitation light source 516, and a water tank 521 have the same functions as those of the first embodiment, the detailed description thereof will not be repeated. Additionally, a point that excitation light 517 is irradiated to an object 515, and a photoacoustic wave 520 is generated and propagated is also similar to the first embodiment.

According to the present embodiment, the optical system 501 configured from the zoom lens optical system is located between a half mirror 502 and a half mirror 503.

As a result, a beam diameter of incident light 504 is changed by an optical system 501, and the incident light 504 is incident upon a Fabry-Perot probe 505. Reflected light 507 reflected on the Fabry-Perot probe 505 is incident upon an array photosensor 506 without changing a beam diameter thereof. As a result, only an imaging area can be changed without changing resolution.

For example, when the beam diameter of the incident light 504 is increased by the optical system 501, an irradiation area of the incident light 504 incident upon the Fabry-Perot probe 505 is expanded. On the other hand, a corresponding spot area on the Fabry-Perot probe 505 per pixel on the array photosensor 506 stays constant. Thus, the imaging area is expanded while keeping the resolution constant.

On the contrary, when the beam diameter of the incident light 504 is reduced by the optical system 501, the imaging area is reduced while keeping the resolution constant.

Thus, the beam diameter of the reflected light 504 is changed by the optical system 501, so that the imaging area can be changed while keeping the resolution constant. A measurer controls the optical system 501 by using the controller, that is, performs zoom control of the zoom lens optical system, according to desired resolution.

FIG. 7C shows an example of relationship among a beam diameter of incident light and reflected light (horizontal axis), resolution (left vertical axis), and a diameter of an imaging area (right vertical axis) when the beam diameter of the incident light 504 is changed by the optical system 501. As shown in the figure, when the beam diameter is reduced, the diameter of the imaging range is reduced.

In this embodiment, as above described, the zoom lens optical system 501 is preferably an object-space telecentric optical system so as not to cause variability in sensitivity due to the detection position of the Fabry-Perot probe.

By using such an imaging apparatus shown in the third embodiment, it is possible to obtain an image while changing the imaging area during imaging by using the Fabry-Perot probe 505.

### Fourth Embodiment

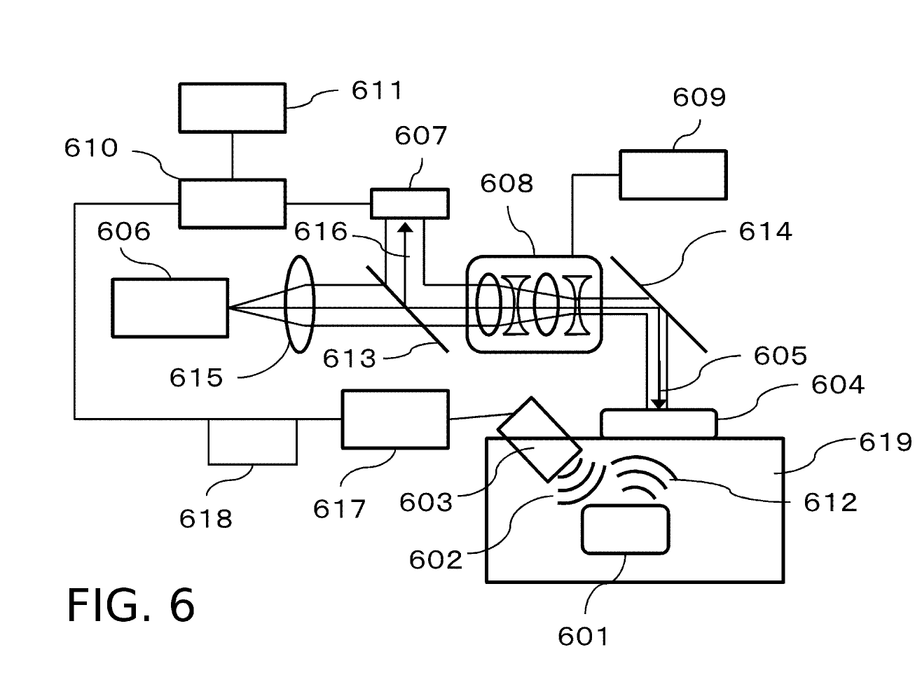

FIG. 6 is a figure illustrating a configuration example of an imaging apparatus according to the present embodiment.

The imaging apparatus according to the present embodiment is an apparatus for creating a picture of acoustic impedance distribution in a biological body by using an ultrasound wave echo technique. Detailed description of configurations similar to the first embodiment will not be repeated.

The imaging apparatus according to the present embodiment includes a transducer 603 irradiating elastic wave 602 to an object 601.

The imaging apparatus further includes a Fabry-Perot probe 604. The Fabry-Perot probe 604 detects an elastic wave reflected on an interface of a tissue, having difference acoustic impedance, of a tumor or the like in the object 601.

Sound pressure can be detected by irradiating measurement light 605 to the Fabry-Perot probe 604 from a measurement light source 606. The imaging apparatus also includes an array photosensor 607 for measuring a light intensity of reflected light of the measurement light 605 incident upon the Fabry-Perot probe 604 and converting the same into an electric signal. Furthermore, the imaging apparatus includes an optical system 608 for changing a beam diameter of the measurement light 605, and a controller 609 for controlling change in the aforementioned beam diameter. The acoustic wave acquiring apparatus is configured in the aforementioned manner.

The imaging apparatus is configured by further including a processor 610 and a display unit 611 in the aforementioned acoustic wave acquiring apparatus. The processor 610 analyzes the electric signal obtained by the array photosensor 607. The display unit 611 displays obtained acoustic impedance distribution information.

The Fabry-Perot probe 604 detects, as light intensity of reflected light change of the measurement light 605, elastic wave (reflected wave) 612 obtained by reflecting the elastic wave 602, which is transmitted to the object 601, on an interface, having different acoustic impedance, of the inside or a surface of the object. The array photosensor 607 converts the change of the light intensity of reflected light into an electric signal. Acquisition of the elastic wave 612 starts by a trigger 618 of an electric signal from a pulsar 617.

Distribution of the electric signals in the array photosensor 607 represents intensity distribution (pressure distribution) of the elastic waves 612 reaching on an area, to which the measurement light 605 is irradiated, in the Fabry-Perot probe 604.

As signal processing for obtaining the acoustic impedance distribution from the distribution of the electric signals obtained, phase rectifying addition or the like can be considered. As long as the processor 610 is a processor capable of storing distribution of time change of electric signals representing intensity of the elastic wave 612 and converting the same into data of the acoustic impedance distribution by computing means, any processor may be used as the processor 610.

After previously considering that an area, in which a film thickness significantly indicates an abnormality such as presence of a foreign material in an element, cannot be utilized as data, a data defective part is corrected at the time of image reconstruction processing and a picture of the part can be created.

Furthermore, suitable data processing is made possible by changing a reconstruction area and a voxel pitch according to the beam diameter of the incident light 605 when performing the image reconstruction, thereby allowing image quality to be improved.

According to the present embodiment, the optical system 608 configured from a zoom lens optical system is located between a half mirror 613 and a mirror 614.

As a result, the beam diameter of the incident light 605 is changed by the optical system 608, and the incident light 605 is incident upon the Fabry-Perot probe 604. Reflected light 616 reflected on the Fabry-Perot probe 604 returns to an original beam diameter by the optical system 608, and is incident upon the array photosensor 607. As a result, resolution and an imaging area can be changed.

For example, when the beam diameter of the incident light 605 is reduced by the optical system 608, an irradiation area of the incident light 605 incident upon the Fabry-Perot probe 604 is reduced as compared with a case where the optical system 608 is not used. On the other hand, a beam diameter when the reflected light 616 is incident upon the array photosensor 607 returns to size when a laser is first emitted, by passing through the optical system 608, and hence does not change as compared with a case where the optical system 608 is not used. Therefore, a corresponding spot area on the Fabry-Perot probe 604 per pixel on the array photosensor 607 is reduced. Due to this, the imaging area can be narrowed, and the resolution can be increased.

Thus, the resolution and the imaging area can be changed by changing the beam diameter of the measurement light 605 by the optical system 608. A measurer controls the optical system 608 by using the controller 609, that is, performs zoom control of the zoom lens optical system, according to desired resolution or imaging range.

According to the present embodiment, although the optical system 608 is located between the half mirror 613 and the mirror 614, the optical system 608 can be located between the array photosensor 607 and the half mirror 613, or between the half mirror 613 and a lens 615.

The zoom lens optical system 608 is preferably an object-space telecentric optical system or double telecentric optical system because of above described reason.

By using such an imaging apparatus shown in the fourth embodiment, it is possible to obtain an acoustic impedance distribution image while changing the resolution and the imaging area during imaging by using the Fabry-Perot probe 604.

When the apparatus is used for medical application, a water tank 619 is not used. In this case, an acoustic impedance matching gel is applied to the object, namely an affected part, the Fabry-Perot probe 604 is arranged on the affected part so as to be in contact with the same, and imaging is performed. At this time, the acoustic coupling medium is not limited to the matching gel. As long as acoustic matching is taken between the affected part and the Fabry-Perot probe 604, other medium can be used as the acoustic coupling medium.

### Practical Example 1

A practical example in which the present invention is applied to actual acoustic wave acquisition will be now described. An imaging apparatus according to the present practical example has a configuration described in the first embodiment.

According to the present practical example, a sample obtained by hardening 1% intralipid solution by agar, and arranging a rubber wire having a diameter of 300 μm, which absorbs light, into the hardened 1% intralipid solution is used as an object. The sample is arranged into water.

A dielectric multilayer film is used for a first mirror and a second mirror of a Fabry-Perot probe. This dielectric multilayer film is designed such that reflectance of light of 1520 nm to 1600 nm is 95% or more. Additionally, BK7 is used for a substrate of the Fabry-Perot probe, a surface of the substrate on a side opposite to a surface formed with the dielectric multilayer film is subjected to AR coating treatment such that the reflectance of the light of 1520 nm to 1600 nm is 1% or less. Parylene C is used for a spacer film between the mirrors, and a film thickness thereof is 30 μm. Furthermore, parylene C is used also for a protective film of the probe.

A measurement light source emitting measurement light is a tunable light source. As this measurement light source, an external cavity laser that is tunable in a range of 1520 nm to 1600 nm is used.

The measurement light emitted from this measurement light source is expanded by a convex lens. Then, after passing through a half mirror, the measurement light has a desired beam diameter by a zoom lens controlled by a controller. Thereafter, the measurement light is incident upon the Fabry-Perot probe by using the mirror.

A zoom lens optical system shown in FIG. 8 is used. It is assumed that focal distance of the convex lens 801 is 80 mm, focal distance of the concave lens 802 is −80 mm and focal distance of the convex lens 803 is 60 mm.

The beam size of the measurement light incident upon the Fabry-Perot probe was set to a diameter of 20 mm. In this situation, the distance d between the concave lens 802 and the convex lens 803 is set as 40 mm and the concave lens 802 and the convex lens 803 are moved so as to their synthesized focal point be positioned at the focal point 804 of the convex lens 801 by the controller.

The measurement light (reflected light) reflected on the Fabry-Perot probe is incident upon a high-speed CCD camera by the half mirror and the mirrors and measured. The size of the high-speed CCD camera is 100×100 pixels.

In such an apparatus, excitation light was irradiated to the object, and measurement of a photoacoustic wave was started. An excitation light source is a titanium sapphire laser, a repetition frequency of emitted pulsed light is 10 Hz, a pulse width is 10 ns, and a wavelength is 797 nm.

Thereafter, image reconstruction is performed by universal back projection algorithm by using distribution of electric signals based on the detected photoacoustic wave. At the time of the reconstruction, a voxel pitch was set to 0.5 mm. Thus, in an imaging area with a diameter of 20 mm, imaging of the rubber wire in 1% intralipid agar as a light diffusion medium was performed.

Thereafter, the distance d between the concave lens 802 and convex lens 803 is set as 10 mm and the concave lens 802 and the convex lens 803 are moved so that their synthesized focal point is positioned at the focal point 804 of the convex lens 801 by the controller.

Thus, the beam size of the measurement light incident upon the Fabry-Perot probe was set to a diameter of 10 mm by the controller. Image reconstruction was performed by using distribution of photoacoustic signals obtained after the measurement. At the time of the reconstruction, a voxel pitch was set to 0.25 mm. As a result, in an imaging area with a diameter of 10 mm, imaging of the rubber wire in 1% intralipid agar as the light diffusion medium was performed with high resolution.

From the above, it has been found that adjustment of an imaging area and resolution at the time of photoacoustic measurement using the Fabry-Perot probe can be attained by changing a diameter of measurement light by using the optical system as in the present practical example.

### Practical Example 2

An imaging apparatus according to the present practical example has a configuration described in the second embodiment. Since the configuration of the present practical example is similar to that of the practical example 1 except a position where a zoom lens optical system 401 is arranged, the detailed description will not be repeated.

According to the present practical example, measurement light emitted from a measurement light source (external cavity laser) is expanded by a convex lens. Thereafter, the measurement light is incident upon a Fabry-Perot probe by using a mirror. A beam diameter of the incident light is 20 mm. That is, zoom control of a zoom lens optical system is not performed for the incident light.

Next, the measurement light (reflected light) reflected after being incident upon the Fabry-Perot probe is reflected on a half mirror. Thereafter, the beam size is set to a diameter of 10 mm by the zoom lens optical system controlled by a controller. As the zoom lens optical system, double telecentric optical system is used.

The measurement light having a desired beam diameter set by a zoom lens is incident upon a high-speed CCD camera and measured. The size of a high-speed CCD camera is 100×100 pixels.

In such an apparatus, excitation light was then irradiated to an object, and measurement of a photoacoustic wave was started.

Thereafter, image reconstruction was performed by universal back projection algorithm by using distribution of photoacoustic signals obtained by the measurement. Thus, in an imaging area with a diameter of 20 mm, imaging of a rubber wire in 1% intralipid agar as a light diffusion medium was performed.

Thereafter, the beam size of the measurement light incident upon the high-speed CCD camera was set to a diameter of 50 mm by the controller. Next, image reconstruction was performed by using distribution of photoacoustic signals obtained after the measurement. As a result, it has been possible to perform imaging of a rubber wire in 1% intralipid agar as the light diffusion medium with high resolution while the diameter of the imaging area is fixed to 20 mm.

From the above, it has been found that adjustment of resolution at the time of photoacoustic measurement using the Fabry-Perot probe can be attained by changing a diameter of measurement light (reflected light) by using the optical system as in the present practical example.

### Practical Example 3

An imaging apparatus according to the present practical example has a configuration described in the third embodiment. Since the configuration and the like of the practical example are similar to those of the practical example 1 except a position where a zoom lens optical system 501 is arranged, the detailed description will not be repeated.

Measurement light emitted from a measurement light source (external cavity laser) is expanded by a convex lens. Thereafter, beam size is set to a diameter of 10 mm by the zoom lens controlled by a controller. As the zoom lens optical system, double telecentric optical system is used.

Then, the measurement light is incident upon a Fabry-Perot probe by a mirror. The measurement light (reflected light) reflected on the Fabry-Perot probe is incident upon a high-speed CCD camera and measured. The size of the high-speed CCD camera is 100×100 pixels.

In such an apparatus, excitation light was irradiated to an object, and measurement of a photoacoustic wave was started.

Thereafter, image reconstruction was performed by universal back projection algorithm by using distribution of the photoacoustic signals obtained by the measurement. Thus, in an imaging area with a diameter of 10 mm, imaging of a rubber wire in 1% intralipid agar as a light diffusion medium was performed.

Thereafter, the beam size of the measurement light incident upon the high-speed CCD camera was set to a diameter of 50 mm by the controller. Next, image reconstruction was performed by using distribution of photoacoustic signals obtained after the measurement. As a result, it has been possible to expand the imaging area to a diameter of 50 mm and perform imaging of a rubber wire in 1% intralipid agar as a light diffusion medium while keeping resolution constant.

From the above, it has been found that adjustment of an imaging area at the time of photoacoustic measurement using the Fabry-Perot probe can be attained by changing a diameter of incident light by using the optical system as in the present practical example.

### Practical Example 4

An imaging apparatus according to the present practical example has a configuration described in the fourth embodiment. Since configurations of a Fabry-Perot probe, an optical system, and a two-dimensional array sensor of the present practical example are similar to those of the practical example 1, the detailed description thereof will not be repeated.

According to the present practical example, imaging of a polyethylene wire having a diameter of 300 μm, which is arranged in an object obtained by hardening 1% intralipid solution with agar, is performed by using the present invention. A phantom is arranged in water.

Measurement light emitted from a measurement light source (external cavity laser) is expanded by a convex lens. Then, after the measurement light passes through a half mirror, a diameter thereof is set to a desired beam diameter by a zoom lens controlled by a controller. Thereafter, the measurement light is incident upon a Fabry-Perot probe by using a mirror. As the zoom lens optical system, object-space telecentric optical system is used.

The beam size of the measurement light incident upon the Fabry-Perot probe is a diameter of 20 mm. The measurement light (reflected light) reflected on the Fabry-Perot probe is incident upon a high-speed CCD camera by the half mirror and the mirror and measured. The size of the high-speed CCD camera is 100×100 pixels.

In such an apparatus, elastic wave was irradiated to the object by using a transducer having a center frequency of 20 MHz. The transducer is a piezoelectric type transducer and PZT is used as a material thereof. An elastic wave is emitted as a pulse wave by using a pulsar, a repetition frequency of the elastic wave is 10 Hz.

Thereafter, an echo wave obtained by reflecting the elastic wave inside the object was measured by the transducer. Then, by using an obtained signal, a picture of acoustic impedance distribution in the object was creased by reconstruction algorithm using phase rectifying addition. Thus, imaging of the polyethylene wire in the agar was performed in an imaging area with a diameter of 20 mm.

Thereafter, the beam size of the measurement light incident upon the Fabry-Perot probe was set to a diameter of 10 mm by the controller. Image reconstruction was performed by distribution of photoacoustic signals obtained after the measurement. At the time of the reconstruction, a voxel pitch was set to 0.25 mm. As a result, in an imaging area with a diameter of 10 mm, imaging of the polyethylene wire in the agar was performed with higher resolution.

From the above, it has been found that an acoustic wave can be acquired by applying the present invention also to an imaging apparatus using an ultrasound wave echo technique.

According to the present invention, in the imaging apparatus using the Fabry-Perot probe, a receiving area of a receiving element or a receiving area (opening) of a probe can be changed by changing a beam diameter of measurement light. As a result, it is possible to obtain an image while changing resolution or an imaging area during imaging.

Accordingly, the resolution or the imaging range can be changed during imaging when imaging a lesioned part of a biological body or the like, and hence identification or extraction of the lesioned part can be effectively performed. For example, a portion suspected as a lesioned part is extracted by first acquiring a rough image having low resolution widely. Thereafter, resolution is increased, imaging of an extracted range is performed with a high definition, and the portion suspected as the lesioned part is fully examined. Thus, the lesioned part can be effectively examined.

The configuration related to the imaging apparatus using a biological body as an object, described in the present specification, can be utilized, for example, as a medical image diagnosis apparatus. That is, a picture of optical properties distribution in the biological body and a picture of concentration distribution of substances constituting a biological tissue obtained from information thereof can be created, for diagnosis of a tumor or blood vessel disease, follow-up of chemical treatment, and the like.

Furthermore, the present invention can be also applied to non-destructive inspection using a non-biological substance as an object, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-283249, filed on Dec. 26, 2011, and, Japanese Patent Application No. 2012-96716, filed on Apr. 20, 2012, which are hereby incorporated by reference herein their entirety.

What is claimed is:

1. An acoustic wave acquiring apparatus comprising:
a measurement light source configured to emit measurement light;
a probe having a Fabry-Perot interferometer including a first mirror, upon the side of which the measurement light is incident, and a second mirror, upon the side of which an elastic wave from an object is incident;
an optical system configured to change a beam diameter of the measurement light;
a controller configured to control the change in the beam diameter performed by the optical system;
a photosensor configured to measure a light intensity of the measurement light reflected on the Fabry-Perot interferometer; and
a processor configured to acquire intensity of the elastic wave on the basis of the change in the light intensity measured by the photosensor due to incidence of the elastic wave.

2. The acoustic wave acquiring apparatus according to claim 1, wherein
the controller is configured to control the optical system such that the beam diameter when the measurement light is incident upon the Fabry-Perot interferometer changes and such that the beam diameter when the measurement light is reflected on the Fabry-Perot interferometer and incident upon the photosensor returns to an original beam diameter.

3. The acoustic wave acquiring apparatus according to claim 2, wherein
the controller is configured to increase resolution of the probe, by controlling the optical system such that the beam diameter when the measurement light is incident upon the Fabry-Perot interferometer reduces, and such that the beam diameter when the measurement light is reflected on the Fabry-Perot interferometer and incident upon the photosensor returns to the original beam diameter.

4. The acoustic wave acquiring apparatus according to claim 2, wherein
the controller is configured to expand an imaging area of the probe, by controlling the optical system such that the beam diameter when the measurement light is incident upon the Fabry-Perot interferometer increases, and such that the beam diameter when the measurement light is reflected on the Fabry-Perot interferometer and incident upon the photosensor returns to the original beam diameter.

5. The acoustic wave acquiring apparatus according to claim 1, wherein
the controller is configured to change resolution without changing an imaging area of the probe, by controlling the optical system such that the beam diameter when the measurement light is reflected on the Fabry-Perot interferometer and incident upon the photosensor changes.

6. The acoustic wave acquiring apparatus according to claim 1, wherein
the controller is configured to change an imaging area without changing resolution of the probe, by controlling the optical system such that the beam diameter when the measurement light is incident upon the Fabry-Perot interferometer changes.

7. The acoustic wave acquiring apparatus according to claim 1, wherein
the optical system is a telecentric optical system.

8. The acoustic wave acquiring apparatus according to claim 1, wherein
the measurement light source is a tunable laser.

9. The acoustic wave acquiring apparatus according to claim 1, further comprising an excitation light source configured to irradiate excitation light to the object, wherein
the elastic wave from the object is a photoacoustic wave generated from the object which the excitation light is irradiated.

10. The acoustic wave acquiring apparatus according to claim 1, further comprising a transducer configured to transmit the elastic wave to the object, wherein
the elastic wave from the object is a wave resulting from the elastic wave transmitted from the transducer being reflected.

11. The acoustic wave acquiring apparatus according to claim 1, wherein
the processor is configured to generate object information representing an optical property of the object by using the intensity of the elastic wave, and change a voxel pitch and an area for generating the object information according to the beam diameter of the measurement light controlled by the controller.
